(19) United States
(12) Patent Application Publication
(10) Pub. No.: US 2008/0283019 A1
(43) Pub. Date: Nov. 20, 2008

(54) DILUTION LIMITING DEVICE

(75) Inventors: Miyao ARAKAWA, Nagoya-city (JP); Masatoshi Kuroyanagi, Kariya-city (JP); Yoshiaki Nishijima, Toyokawa-city (JP); Yoshimichi Kiyozumi, Sendai-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/118,835

(22) Filed: May 12, 2008

(30) Foreign Application Priority Data
May 14, 2007 (JP) 2007-128566

(51) Int. Cl. F16N 39/00

(52) U.S. Cl. 123/196 R; 184/6.24

(57) ABSTRACT

An anterior chamber receives a mixture fluid, in which a lubricant oil and a fuel are mixed. A semipermeable separation film is permeable to the fuel component in the anterior chamber and is not permeable to the lubricant oil in the anterior chamber due to a molecular size difference between the lubricant oil and the fuel, so that the semipermeable separation film selectively separates the fuel component from the mixture fluid. A posterior chamber is placed on an opposite side of the semipermeable separation film, which is opposite from the anterior chamber. The posterior chamber receives the separated fuel component, which is separated by the semipermeable separation film.

### CROSS REFERENCE TO RELATED APPLICATION

This application is based on and incorporates herein by reference Japanese Patent Application No. 2007-128566 filed on May 14, 2007.

### BACKGROUND OF THE INVENTION

1. Field of the Invention

The present invention relates to a dilution limiting device.

2. Description of Related Art

In an internal combustion engine of a direct fuel injection type, fuel is directly injected into a combustion chamber of each cylinder Lubricant oil is applied to form a lubricant oil film between a piston and a wall of the combustion chamber to limit seizing. When fuel adheres to the lubricant oil film, the fuel may possibly be mixed into the lubricant oil and may possibly be circulated in a lubricant oil circuit, which includes an oil pan. Thus, it is required to limit dilution of the lubricant oil by the fuel. Japanese Unexamined Patent Publication No. 2004-340056 teaches a lubricant oil dilution limiting technique.

According to this technique, a heater is placed in a bottom portion of the oil pan to heat the lubricant oil. The fuel component is separated from the lubricant oil through use of a boiling point difference between the lubricant oil and the fuel.

According to this technique, the lubricant oil, in which the fuel is mixed, may be heated by the heater to vaporize the fuel. However, the fuel component includes a material that has a high boiling point, so that such a material may possibly be left in the lubricant oil.

In view of the above point, it is conceivable to increase the heating temperature of the oil by the heater to more effectively separate the fuel from the lubricant oil. However, when the heating temperature is increased without setting a limit, the lubricant oil is disadvantageously degraded.

### SUMMARY OF THE INVENTION

The present invention addresses the above disadvantages. According to one aspect of the present invention, there is provided a dilution limiting device, which includes an anterior chamber; a semipermeable separation film and a posterior chamber. The anterior chamber receives a mixture fluid, in which a lubricant fluid having lubricity and a diluent fluid are mixed. The diluent fluid reduces the lubricity of the lubricant fluid. The semipermeable separation film is permeable to the diluent fluid in the anterior chamber and is not permeable to the lubricant fluid in the anterior chamber due to a molecular size difference between the lubricant fluid and the diluent fluid, so that the semipermeable separation film selectively separates the diluent fluid from the mixture fluid. The posterior chamber is placed on an opposite side of the semipermeable separation film, which is opposite from the anterior chamber. The posterior chamber receives the separated diluent fluid, which is separated by the semipermeable separation film.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a lubricant oil filtering system of an internal combustion engine having a dilution limiting device according to a first embodiment of the present invention;

FIG. 2 is a longitudinal schematic cross sectional view of a fuel component separator according to the first embodiment;

FIG. 3 is an enlarged partial longitudinal view of a section indicated by III in FIG. 2;

FIG. 4 is a further enlarged partial longitudinal view of a section indicated by IV in FIG. 3;

FIG. 5 is a diagram showing a relationship between a pressure difference applied to a component separation wall of FIG. 3 and a separating performance (separating speed);

FIG. 6 is a diagram for describing a separation principle used in separation of a fuel component from oil through a separation film of the component separation wall and showing a relationship between a carbon number (indicating a molecular size) and a boiling point;

FIG. 7 is a flowchart indicating a control method for controlling the lubricant oil filtering system having the dilution limiting device according to the first embodiment;

FIG. 8 is a time chart for describing an operation of the lubricant oil filtering system upon execution of the control method shown in FIG. 7;

FIG. 9 is a schematic diagram showing a lubricant oil filtering system of an internal combustion engine having a dilution limiting device according to a second embodiment of the present invention;

FIG. 10 is a schematic diagram showing a position of a fuel component separator of a dilution limiting device according to a third embodiment of the present invention;

FIG. 11 is a schematic diagram showing a position of a separator of a dilution limiting device according to a fourth embodiment of the present invention; and

FIG. 12 is a diagram for describing a separation method of a prior art technique for separating an oil component and a fuel component from one another and showing a relationship between a carbon number (indicating a molecular size) and a boiling point.

### DETAILED DESCRIPTION OF THE INVENTION

Various embodiments of the present invention, in which a dilution limiting device of the present invention is implemented in a lubricant oil filtering system of an internal combustion engine, will be described with reference to the accompanying drawings.

### FIRST EMBODIMENT

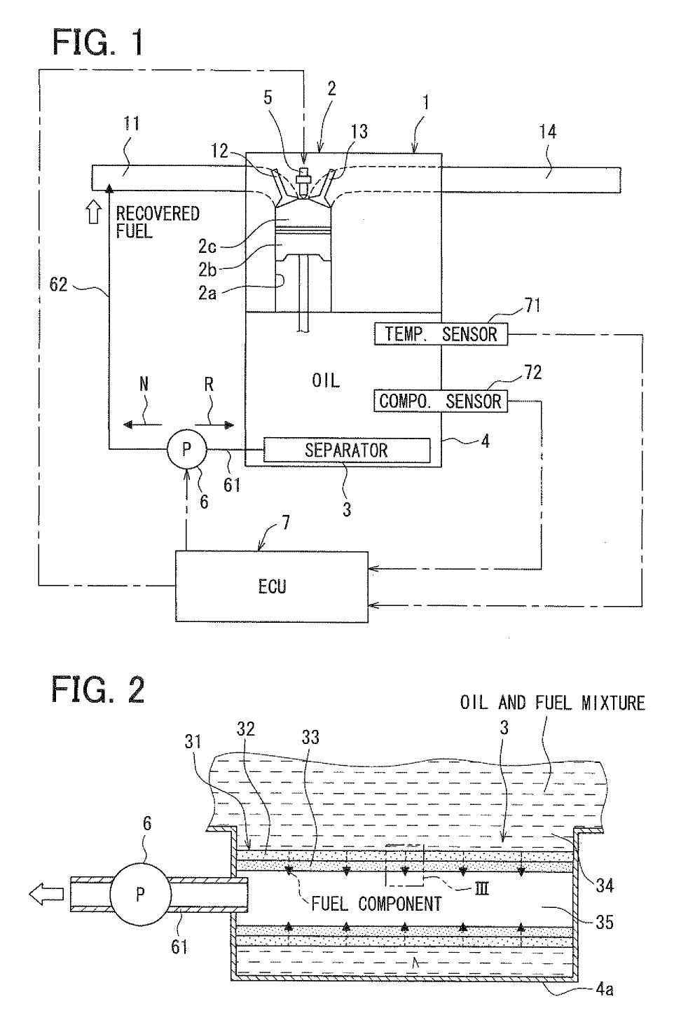

A lubricant oil filtering system according to a first embodiment of the present invention will be described with reference to FIGS. 1 to 8. FIG. 1 shows a system structure of the lubricant oil filtering system of the internal combustion engine, in which the dilution limiting device is implemented. In this instance, the engine 1 is a multi-cylinder (e.g., four cylinder) engine. In the engine 1, a fuel injection valve 5 is provided in a combustion chamber 2c of each cylinder 2. Fuel, which is stored in a fuel tank, is pumped by a fuel pump to the fuel injection valve 5 through a delivery pipe (not shown).

The fuel tank stores gasoline as the fuel. The fuel is not limited to the gasoline and may alternatively be, for example, a blended fuel (e.g., gasohol), in which the gasoline is mixed with alcohol.

An intake pipe 11 is connected to a cylinder bore 2a of each cylinder 2, in which a piston 2b is reciprocably received. At the lower side of the cylinder bore 2a, a crankcase of the engine and an oil pan (serving as a lubricant oil storage) 4 are provided. The oil pan 4 stores a lubricant oil (an engine oil that will be hereinafter simply referred to as an oil), which lubricates between the piston 2b and an inner peripheral wall surface of the cylinder bore 2a. The oil pan 4 is placed to close a bottom opening of the crankcase. Appropriate amount of oil is stored in the oil pan 4 to lubricate the corresponding parts of the engine 1.

Although not depicted in FIG. 1, the oil pan 4 forms a part of a known lubricant oil circuit (also referred to as a lubricant oil path), which includes a pump (hereinafter, referred to as an oil pump) that pumps oil stored in the oil pan 4 to implement the lubricating function of the oil at the engine 1. Besides the oil pump, the lubricant oil circuit includes an oil filter, which serves as a contaminant filtering device that filters contaminants (e.g., debris sludge) contained in the oil.

A spark plug (not shown) is installed at an upper wall of the cylinder bore 2a. An intake valve 12 and an exhaust valve 13 are provided such that the spark plug is placed between the intake valve 12 and the exhaust valve 13. The intake valve 12 opens and closes a connection between the combustion chamber 2c and the intake pipe 11. The exhaust valve 13 opens and closes a connection between the combustion chamber 2c and an exhaust pipe 14.

Blowby gas, which leaks through a gap between the piston 2b and the inner peripheral wall surface of the cylinder bore 2a, is present in the interior of the crankcase. The blowby gas in the crankcase is processed through a known blowby gas processing mechanism (not shown) and is outputted into the intake pipe 11.

Here, besides the blowby gas, the fuel, which adheres to the wall surface of the cylinder bore 2a, may also leak through the gap between the piston 2b and the wall surface of the cylinder bore 2a. The leaked fuel or vaporized fuel can be easily dissolved into the liquid, which contains high-boiling component, such as the oil, as its major component.

An air cleaner (not shown) is placed at the upstream side portion of the intake pipe 11. Fresh air (hereinafter referred to as intake air) is drawn through an air filter, which is received in the air cleaner.

An airflow sensor is placed on a downstream side of the air cleaner. The airflow sensor measures an intake air quantity and outputs its measurement to an electronic control unit (ECU) 7, which serves as a control means. The ECU 7 is connected with various sensors, which provides measurements (e.g., an opening degree of a throttle valve, a rotational speed of the engine) that are used to determine an engine operational state. The ECU 7 controls the throttle valve, the fuel injection valves 5 and the spark plugs to place the engine in the best operational state based on the measurements of the sensors. Other mechanisms are similar to those of the ordinary engine.

Next, the characteristic feature of the present invention will be described with reference to FIGS. 1 and 2. FIG. 2 depicts a separator (hereinafter, referred to as a fuel component separator) 3, which separates the fuel (hereinafter, also referred to as a fuel component) from the oil, in which the fuel is mixed. The fuel component separator 3 is placed in the oil at a bottom part of the oil pan 4. The fuel component separator 3 serves as a separating means of the present invention.

The fuel component separator 3 selectively separates the fuel component from the oil, in which the fuel (gasoline) is mixed, so that the fuel component separator 3 limits dilution of the oil by the fuel. As shown in FIG. 1, a fuel component recovery pipe 61, a pump 6 and a fuel component output pipe 62 are connected to the fuel component separator 3. The separated fuel component is passed into the fuel component output pipe 62 from the fuel component recovery pipe 61, which is connected to the fuel component separator 3, through the pump 6, and is recovered from the fuel component output pipe 62 into the intake pipe 11.

The pump 6 is connected to a downstream end of the fuel component recovery pipe 61 to provide a differential pressure between an exterior of the fuel component separator 3 (an anterior chamber 34 that is supplied with the oil mixed with the fuel) and an interior of the fuel component separator 3 (a posterior chamber 35 that temporarily stores the separated fuel component). The fuel component separating operation and the fuel component recovering operation are controlled by the ECU 7, which serves as a differential pressure control means for controlling the pressure difference between the exterior and the interior of the fuel component separator 3 caused by the pump 6.

The ECU 7 further receives signals from an oil temperature sensor (a lubricant oil temperature sensing means) 71 and an oil component sensor (a lubricant oil component analyzing means) 72 besides the above-described sensors used for sensing the operational state of the engine. The oil temperature sensor 71 measures a temperature of the oil stored in the oil pan 4. The oil component sensor 72 analyzes the oil component (thereby providing a fuel content, i.e., a degree of fuel dilution in the oil). Sometimes, the oil component sensor 72 is also referred to as an oil condition sensor.

The pump (hereinafter, also referred to as a depressurizing pump) 6 is a pump that has a known structure, which can perform both of pressurization and depressurization. Here, the pump 6 depressurizes the interior (the posterior chamber 35) of the fuel component separator 3 to exert the negative pressure. The pump 6 serves as a differential pressure creating means of the present invention. Furthermore, the pump 6 also serves as a pressure pump of the present invention. Specifically, the pump 6 acts as a common pressure pump, which can operate at both of the fuel component separating time period and the other time period by reversing the pumping direction of the pressure pump.

Next, details of the fuel component separator 3 will be described with reference to FIGS. 2 to 4. As shown in FIG. 2, the fuel component separator 3 has a component separation wall 31, which includes a porous support body 33 and a fuel component separation film (serving as a semipermeable separation film) 32. The porous support body 33 is configured into a tubular body (pipe) that bridges between a left wall and a right wall in the oil pan 4 in FIG. 2. The fuel component separation film 32 is a separation film, which is layered over an outer peripheral wall of the porous support body 33 and through which the fuel component can selectively penetrate, i.e., permeate.

One end of the component separation wall 31 is securely held by the right wall of the oil pan 4, and the other end of the component separation wall 31 is securely connected to the fuel component recovery pipe 61, which opens in the left wall of the oil pan 4. Furthermore, the component separation wall 31 is slightly spaced away from a bottom wall 4a of the oil pan 4. In some applications, the component separation wall 31 may possibly contact the bottom wall 4a of the oil pan 4, if desired. The fuel, which has leaked out through the gap between the piston 2b and the inner peripheral wall surface of the cylinder bore 2a, is dissolved into the oil in the oil pan 4. The interior of the oil pan 4 is divided by the component separation wall 31 into two chambers, i.e., the anterior chamber 34 and the posterior chamber 35. The anterior chamber 34 is located radially outward of the component separation wall 31 and is supplied with the oil, which contains the contaminants and is used to lubricate the engine 1. The posterior chamber 35 is located radially inward of the component separation wall 31 and temporarily stores the fuel component, which have passed through the separation wall 31. The posterior chamber 35 is communicated with the fuel component output pipe 62, which extends to the intake pipe 11, through the fuel component recovery pipe (serving as a low pressure side passage) 61 and the pump 6.

The oil, which is mixed with the fuel and is supplied to the anterior chamber 34, is stored in the oil pan 4, so that this oil is placed generally under the atmospheric pressure. In contrast, the posterior chamber 35 is depressurized by the pump 6, and a predetermined negative pressure (in the present embodiment, 30 Pa) is exerted in the posterior chamber 35. Thus, when the ECU 7 operates the pump 6 to perform the depressurizing operation for exerting the negative pressure, the fuel component, which is contained in the oil, is passed through the component separation wall 31 by use of the pressure difference between the interior and exterior of the component separation wall 31, so that the fuel component is separated from the anterior chamber 34 into the posterior chamber 35.

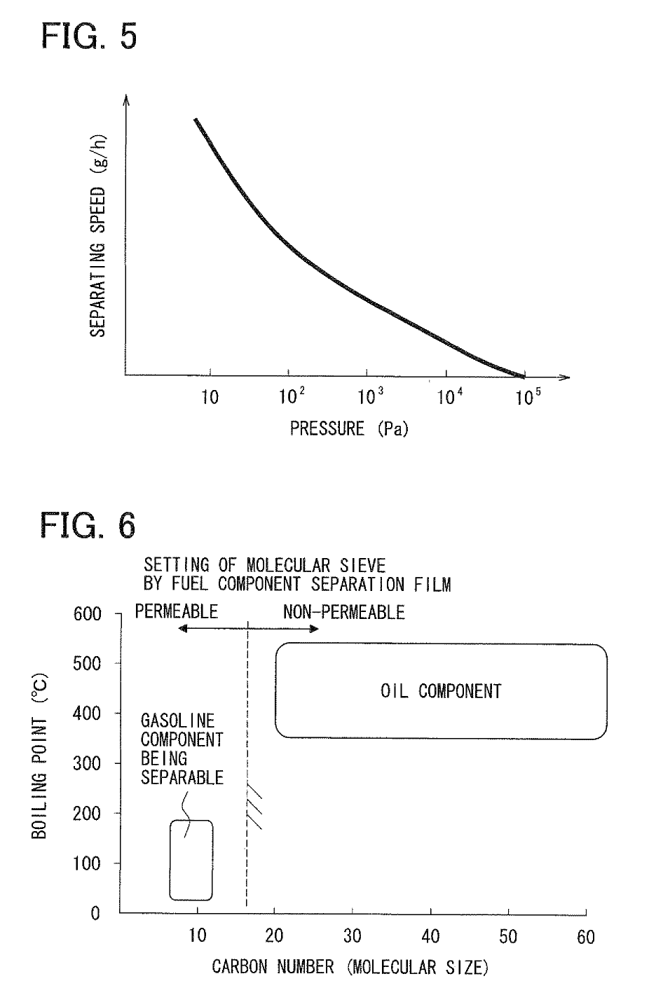

FIG. 5 shows a separating performance (a separating speed), which is achieved by the predetermined negative pressure of the pump 6 and the fuel component separation film 32. As shown in FIG. 5, when the depressurizing operation of the pump 6 is stopped, the pressure difference between the interior and the exterior of the component separation wall 31 disappears to stop the separating operation for separating the fuel component from the oil.

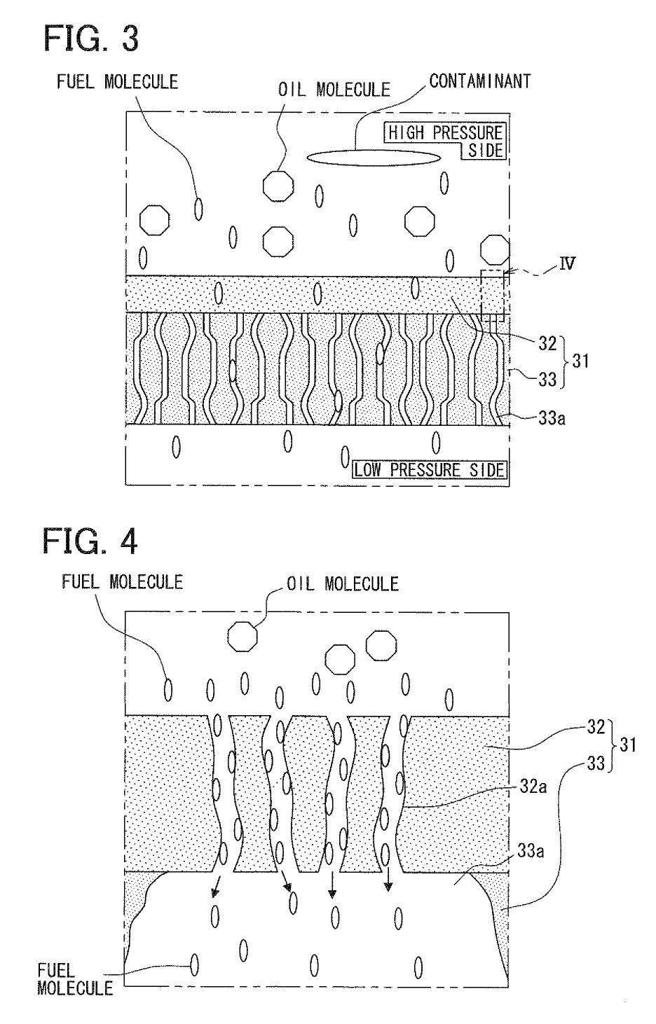

FIG. 3 is an enlarged view of a section III in FIG. 2 and shows a detailed structure of the component separation wall 31. The porous support body 33, which forms an inner peripheral wall of the component separation wall 31, is the porous pipe, which is made of ceramics (e.g., mullite) or metal (e.g., stainless steel) and includes a plurality of fine pores 33a that are sized to easily pass the molecules of the fuel component therethrough. A size (a diameter) of the fine pore 33a is generally in a range of about 10 nm to 100 μm and is made to be larger than fine pores 32a of the fuel component separation film 32 (FIG. 4). Mullite is relatively inexpensive material. Thus, when mullite is used as the porous ceramics, the manufacturing cost can be advantageously reduced. The porous metal may be made of fine metal wires, which are formed into a mesh structure, or may be made of fine metal fibers, which are formed into a porous body.

The fuel component separation film 32, which forms an outer peripheral wall of the component separation wall 31, is constructed to cover the entire outer peripheral surface of the porous support body 33. As shown in FIG. 4, which is an enlarged view of a section IV in FIG. 3, a size (a pore diameter or pore size) of the fine pores 32a of the fuel component separation film 32 is generally in a range of 0.3 to 10 nm. In a case where a molecular sieve is used to separate the fuel component, the pore size may be made smaller than the molecules of the oil component. Alternatively, in a case where the fuel component is separated in view of the difference in the degree of adsorption, the pore size may be made larger than the molecules of the oil component. The fuel component is separated from the oil, in which the fuel is mixed, by using the molecular sieve or the difference in the degree of adsorption between the molecules of the fuel component and the molecules of the oil component.

For example, a zeolite film (e.g., Na—X type, Na—Y type or T type) or a mesoporous silica film (serving as a mesoporous film) can be advantageously used as the fuel component separation film 32. The fuel component separation film 32 can be formed on the outer peripheral surface of the porous support body 33 by, for example, crystal growth using a hydrothermal synthesis method. For example, in a case where the wall thickness of the porous support body 33 is in a range of 0.5 to 3 mm, it is preferred that the fuel component separation film 32 has a film thickness of 1 to 50 μm.

FIG. 6 is a diagram for describing a separation principle used in the separation of the fuel component from the oil through the separation film 32 of the component separation wall 31. More specifically, FIG. 6 shows a relationship between a carbon number (indicating a molecular size) and a boiling point. The gasoline is refined to have the boiling point range of about 30 to 200 degrees Celsius and has the molecular size of about 4 to 10 carbon atoms (hereinafter, the number of carbon atoms will be referred as the carbon number). Furthermore, the oil has the high boiling point range, which is equal to or higher than 300 degrees Celsius, and has the carbon number of equal to or larger than 20.

As indicated by a dotted line in FIG. 6, the molecular sieve function (pore size) of the fuel component separation film 32 is set between the upper limit carbon number of the fuel component and the lower limit carbon number of the oil, so that the fuel component is passed through the fuel component separation film 32 while the oil cannot pass through the fuel component separation film 32. Therefore, the fuel component can be selectively passed into the interior (the posterior chamber 35) of the fuel component separator 3 regardless of the oil temperature in the oil pan 4.

In contrast, FIG. 12 shows a comparative example, in which a difference between the boiling point of the oil and the boiling point of the fuel is used to separate the fuel from the oil. In this comparative example, a heater is provided to heat the oil, which is stored in the oil pan. In order to separate the fuel component from the oil, the heating temperature of the oil needs to be set to equal to or higher than the boiling point of the fuel component. However, besides the degradation of the oil caused by the dilution of the oil by the fuel, the heating of the oil causes the thermal degradation of the oil. Therefore, the heating temperature for heating the oil with the heater has the upper limit. As a result, as shown in FIG. 12, some material of the fuel (gasoline), which has the high boiling point, cannot be vaporized and thereby cannot be separated from the oil, so that such a material of the fuel (gasoline) is left in the oil.

Unlike the comparative example, according to the present embodiment, the fuel component separator 3 has the separating capability for reliably separating the fuel component from the oil without causing the thermal degradation of the oil.

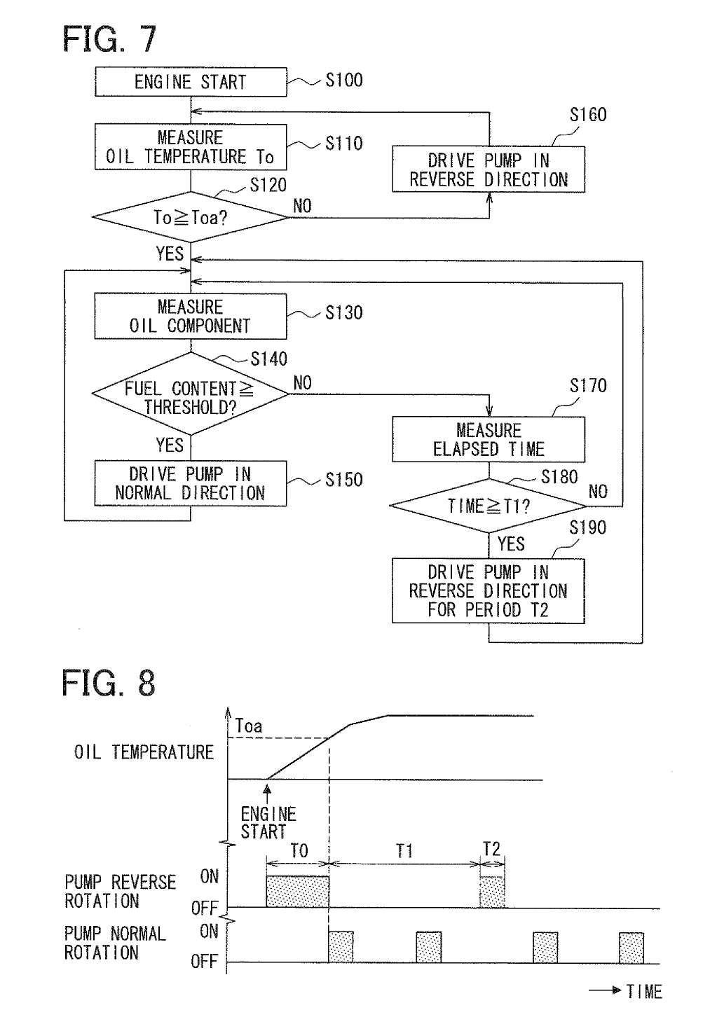

Now, an operation of the lubricant oil filtering system will be described with reference to FIG. 7 in view of FIGS. 1 to 6.

First, at step S100, when the engine 1 is started, the ECU 7 proceeds to step S110. At step S10, the oil temperature To is measured with the oil temperature sensor 71 installed in the oil pan 4. Then, at step S120, it is determined whether the measured oil temperature To is equal to or higher than a predetermined temperature Toa (i.e., To≧Toa). When it is determined that the oil temperature To is equal to or higher than the predetermined temperature Toa at step S120, the ECU 7 proceeds to step S130. At step S130, the oil component is measured with the oil component sensor 72, and then the ECU 7 proceeds to step S140.

In contrast, when it is determined that the oil temperature To is less than the predetermined temperature Toa at step S120, the ECU 7 proceeds to step S160.

At step S140, it is determined whether the fuel content (also commonly referred to as the degree of fuel dilution) in the oil, which is obtained based on the measurement of the oil component sensor 72, is equal to or higher than a predetermined threshold value (a predetermined threshold fuel content or a predetermined threshold degree of fuel dilution). This predetermined threshold value is a threshold value for determining whether the separating operation, which separates the fuel component from the oil, needs to be executed. The threshold value may be set to any appropriate value regardless of whether the fuel content is held equal to or above a limit fuel content (a limit degree of fuel dilution), equal to or above which the fuel component mixed in the oil substantially deteriorates the lubricating function of the oil. Here, it is desirable to set the threshold value based on the above limit fuel content in view of an allowance rate. In the present embodiment, the threshold value is set to a predetermined fuel content (or a predetermined degree of fuel dilution).

When it is determined that the fuel content in the oil is equal to or higher than the threshold value at step S140, the ECU 7 proceeds to step S150. At step S150, the pump 6 is driven to execute the depressurizing operation thereof (hereinafter, the rotational direction of the pump 6 in the depressurizing operation will be referred to as a normal direction indicated by an arrow N in FIG. 1). Thereby, the negative pressure (30 Pa) is applied to the interior (the posterior chamber 35) of the fuel component separator 3. Thus, the fuel component in the oil of the anterior chamber 34 under generally the atmospheric pressure is forced to move through the fuel component separation film 32 and the porous support body 33 of the component separation wall 31 into the posterior chamber 35.

The fuel component, which is accumulated in the posterior chamber 35, passes through the fuel component recovery pipe 61 and the pump 6 and is thereafter recovered from the fuel component output pipe 62 into the intake pipe 11, so that the recovered fuel component is finally supplied to the combustion chamber 2c. As described above, the recovered fuel component is consumed in the engine 1 without being expelled to the outside environment.

In the control operation executed at step S150, a driving time period of the pump 6 (also referred to as an active separating period for actively separating the fuel component from the lubricant oil) in the depressurizing operation may be set to a predetermined time period (see FIG. 8). Alternatively, the driving time period of the pump 6 may be varied. Specifically, the depressurizing operation may be started when the fuel content becomes equal to or higher than the threshold value. Thereafter, when the fuel content drops below the threshold value, the depressurizing operation may be stopped, and so on. This operation may be made possible due to the fact that after the control operation at step S150, the ECU 7 returns to step S130, at which the level of improvement in the fuel content (the degree of fuel dilution) is determined, and then it is determined whether the pump 6 needs to be driven to execute the depressurizing operation based on the level of the improvement.

In contrast, when it is determined that the fuel content is less than the threshold value at step S140, the ECU 7 proceeds to step S170.

The control operation at steps S160 and 5170 to S190 is executed to perform a regenerating operation (hereinafter, referred to as a separation film regenerating operation) for regenerating, i.e., reviving the separating function of the fuel component separation film 32.

Here, in the separating process for selectively separating the fuel component mixed into the oil using the fuel component separation film 32, the contaminants (e.g., the debris, sludge) contained in the oil may possibly adhere to the fuel component separation film 32. The molecular sizes of the contaminants (e.g., the debris, sludge) are substantially larger than the molecular size of the fuel component and the molecular size of the oil component. Therefore, even when the contaminants adhere to the fuel component separation film 32, the contaminants will not get into the fine pores of the fuel component separation film 32 to clog the same. However, due to the size of the contaminants, the clogged area (covered area) of the fuel component separation film 32 (i.e., the covered area of the component separation wall 31), which is clogged, i.e., covered with the contaminants, may possibly lose its separating function for selectively separating the fuel component from the oil.

Therefore, in the case where the contaminants adhere to the area of the component separation wall 31 or in the case where the adhesion of the contaminants is expected based on the cumulative time of the separating operation or based on the operation time (e.g., the elapsed operational time of the engine), it is desirable to perform the separation film regenerating operation of the fuel component separator 3 to recover the initial performance of the separating function of the fuel component separator 3.

In the control operation at step S160, at the time of starting the engine 1, when the engine 1 is cold, i.e., when the oil temperature To is relatively low (To<Toa), the ECU 7 rotates the pump 6 in a reverse direction, which is opposite from the normal direction N and indicated by an arrow R in FIG. 1, to perform the pressurizing operation for exerting the positive pressure. In this way, separation film regenerating operation of the fuel component separator 3 is performed.

Specifically, the rotational direction of the pump 6 is reversed at step S160, so that the pressurizing operation is performed to apply the positive pressure to the interior (the posterior chamber 35) of the fuel component separator 3. A driving time period for driving the pump 6 in the pressurizing operation is set to a predetermined time period (T0). After the control operation at step S160, the ECU 7 proceeds to step S110. Therefore, at the time of starting the engine 1, the separation film regenerating operation is continuously performed until the oil temperature To reaches the predetermined temperature Toa (see FIG. 8).

Furthermore, in the control operation from step S170 to step S190, when the engine 1 is hot, i.e., when the oil temperature To is relatively high (To≧Toa), the ECU 7 temporarily permits the separation film regenerating operation upon satisfaction of a predetermined regenerating operation execution condition.

The predetermined regenerating operation execution condition may be satisfied when the fuel content in the oil is kept below the threshold value for a predetermined time period. This is due to the fact that the current fuel content is stabilized at the sufficiently low level in comparison to the limit fuel content, equal to or above which the adverse influence on the engine 1 is expected. Thus, when the separation film regenerating operation is temporarily performed, the separation film regenerating operation can be performed without causing the adverse influence on the engine 1.

Specifically, at step S170, the elapsed time period is measured from the time of dropping the fuel content below the threshold value. Then, at step S180, it is determined whether the elapsed time period has reached to a predetermined time period T1. When it is determined that the elapsed time period has not reached to the predetermined time period T1 at step S180, it is determined that the regenerating operation execution condition has not been satisfied. Thus, the ECU 7 returns to step S130.

In contrast, when it is determined that the elapsed time period has reached to the predetermined time period T1 at step S180, it is determined that the regenerating operation execution condition has been satisfied. Thus, the ECU 7 proceeds to step S190. At step S190, as shown in FIG. 8, the ECU 7 operates the pump 6 to perform the pressurizing operation for exerting the positive pressure for a predetermined time period T2 and thereafter proceeds to step S130.

In the present embodiment, the fuel component separator 3, which selectively separates the fuel component from the oil, is provided in the oil pan 4. The fuel component separator 3 includes the fuel component separation film 32, which selectively separates the fuel component from the oil based on the molecular size difference between the oil component and the fuel component.

In this way, unlike the prior art technique, the fuel component can be effectively separated from the oil through the fuel component separation film 32 without a need for using the difference between the boiling temperature of the oil component and the boiling temperature of the fuel component. Therefore, it is possible to reliably limit the oil dilution by the fuel without promoting the degradation of the oil by heat.

Furthermore, according to the present embodiment, it is desirable that the fuel component separation film 32 is one of the zeolite film and the mesoporous film (e.g., the mesoporous silica film), through which the predetermined component can pass.

Thus, it is possible to use the zeolite film or the mesoporous silica film as the separation film, through which the fuel component (the predetermined component) can pass to separate the fuel component from the oil. These films (the zeolite film, the mesoporous silica film) have the fine pores 32a, which are sized to correspond with the fuel component (the separating subject). Through use of the molecular sieve function or the difference in the degree of adsorption at the fine pores 32a, the fuel component is selectively passed through the fine pores 32a while the oil component is not.

Also, according to the present embodiment, the fuel component separator 3 has the component separation wall 31, which includes the fuel component separation film 32 and the porous support body 33. The porous support body 33 supports and is covered with the fuel component separation film 32. Furthermore, the pump (the depressurizing pump) 6 is provided to generate the pressure difference between the exterior and the interior of the fuel component separator 3, i.e., between the anterior chamber 34 and the posterior chamber 35.

With this construction, the fuel component separation film 32 is placed over the porous support body 33 to form the component separation wall 31, so that the strength of the fuel component separation film 32 against an external force is improved by the support provided by the porous support body 33. Furthermore, the pump 6 is provided to generate the pressure difference between the anterior chamber 34 and the posterior chamber 35, which are partitioned by the component separation wall 31. Thereby, the performance for selectively separating the fuel component from the oil can be improved by using the pressure difference created by the pump 6.

Also, the pump 6, which creates the pressure difference between the anterior chamber 34 and the posterior chamber 35, can rotate in both the normal direction and the reverse direction to exert the negative pressure and the positive pressure. Therefore, when the pump 6 exerts the negative pressure to the posterior chamber 35, which temporarily stores the fuel component separated from the oil upon passing through the component separation wall 31, the separated fuel component can be vaporized in the posterior chamber 35. When the separated fuel component is vaporized in the above described manner to create the vapor fuel, the vapor fuel can be recirculated into, for example, the intake pipe 11 without releasing it to the outside environment. Thereby, the vapor fuel can be advantageously recycled.

Here, it should be noted that the source of the negative pressure is not limited to the pump 6. For example, the negative intake pressure, which is created at the time of taking the intake air at the engine 1, can be used to exert the negative pressure at the posterior chamber 35. The pump and the negative intake pressure are negative pressure sources, which can be easily obtained at the engine 1.

Also, according to the present embodiment, the oil component sensor 72 is provided to analyze the oil component and thereby to measure the fuel content (the degree of fuel dilution) in the oil. Desirably the ECU 7 operates the pump 6 (or the negative intake pressure source) to selectively separate the fuel component mixed in the oil through the fuel component separator 3 based on the information indicating the fuel content (the degree of fuel dilution) in the oil obtained from the signal of the oil component sensor 72.

In this way, the fuel component separator 3 will not be operated all the time regardless of the fuel content (the degree of fuel dilution) in the oil. Therefore, the fuel component separator 3, more specifically, the fuel component separation film 32 will have an increased lifetime.

Furthermore, in the present embodiment, the control means implemented by the ECU 7, which controls the pump 6, preferably includes a regenerating operation executing means for applying the pressure difference (the positive pressure) in the direction opposite from that of the case where the differential pressure (the negative pressure) is applied between the anterior chamber 34 and the posterior chamber 35 at the time of separating the fuel component from the oil.

In this way, the fuel component in the posterior chamber 35, which has been separated by the fuel component separation film 32, can be used to blow the contaminants adhered to the area of the fuel component separation film 32. Thereby, the separating function of fuel component separation film 32 can be returned to the initial state. As a result, the regenerating operation may be performed within the range where the oil dilution by the fuel does not cause the adverse influence on the engine, so that the oil dilution limiting function of the fuel component separation film 32 can be maintained for a long time.

Furthermore, the control means, which is implemented by the ECU 7, desirably includes a regenerating operation determining means for determining that the regenerating operation execution condition is satisfied when the engine operational state (operational condition) is in at least one of the engine start state and the low temperature state (the state where the oil temperature To is lower than the predetermined temperature Toa).

In this way, when the engine 1 is in the at least one of the engine start state and the low temperature state, the regenerating operation determining means determines that the regenerating operation execution condition is satisfied. Therefore, the regenerating operation executing means can appropriately perform the regenerating operation during the period of satisfying the regenerating operation execution condition. Therefore, the regenerating operation is not unduly executed.

The operational condition, which satisfies the above regenerating operation execution condition, is set to include the engine start state and/or the low temperature state due to the fact that the influence of the oil dilution by the fuel is relative small in these states.

In the above embodiment, the regenerating operation determining mans may determine that the regenerating operation execution condition is temporarily satisfied in the high temperature state where the oil temperature To is equal to or higher than the predetermined temperature Toa.

In this way, the temporal regenerating operation can be appropriately performed during the operational period where the engine 1 is in the high temperature state within the range where the oil dilution by the fuel does not cause the adverse influence on the engine 1.

### SECOND EMBODIMENT

Other embodiments of the present invention will be described below. In the following embodiments, the components, which are similar to those of the first embodiment will be indicated by the same reference numerals and will not be described further for the sake of simplicity.

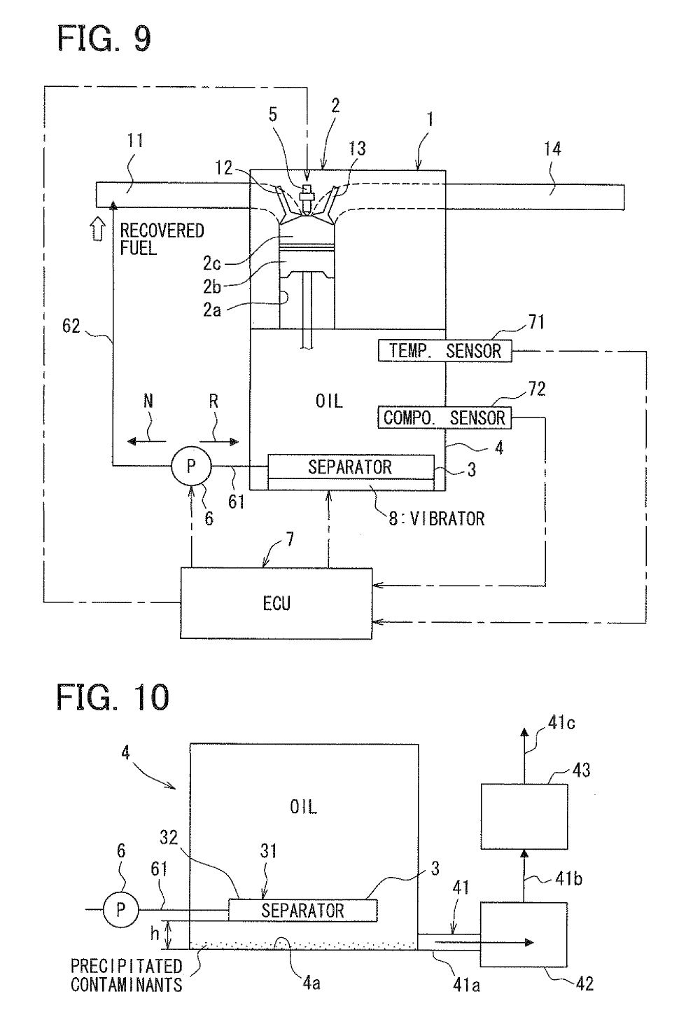

FIG. 9 shows a second embodiment of the present invention. In the second embodiment, a vibrator (a vibrating means) 8 is provided to vibrate the fuel component separation film 32 and serves as the regenerating means for regenerating the separating function of the fuel component separation film 32.

As shown in FIG. 9, the vibrator 8 is placed between the fuel component separator 3 and the bottom portion of the oil pan 4.

The contaminants merely adhere to the fuel component separation film 32. Thus, when the fuel component separation film 32 is vibrated by the vibrator 8 upon receiving a corresponding command from the ECU 7, the contaminants can be shaken off from the area of the fuel component separation film 32, to which the contaminants adhere. As a result, the contaminants can be advantageously removed from the fuel component separation film 32 regardless of the separating process and the non-separating process.

The regenerating means preferably includes both of the vibrator (vibrating means) 8 and the regenerating operation executing means, which applies the positive pressure to the posterior chamber 35 through the pump 6. In this way, the regenerating operation for regenerating the separating function of the fuel component separation film 32 can be performed within a relatively short period of time. As a result, the oil dilution limiting function of the fuel component separator 3 can be regenerated within the range where the oil dilution by the fuel does not cause the adverse influence on the engine 1, so that the oil dilution limiting function can be maintained for a long time.

### THIRD EMBODIMENT

FIG. 10 shows a third embodiment of the present invention. In the third embodiment, the fuel component separator 3 is further spaced from the bottom wall 4a of the oil pan 4 in comparison to the first embodiment.

As shown in FIG. 10, the fuel component separator 3 is spaced by a predetermined height h from the bottom wall 4a at the bottom portion of the oil pan 4. In this way, the fuel component separator 3 is sufficiently spaced from the bottom wall 4a at the bottom portion of the oil pan 4 on which the contaminants (e.g., debris, slug) tend to precipitate. Therefore, it is possible to limit adhesion of the precipitated contaminants to the fuel component separator 3, more specifically, the fuel component separation film 32. Furthermore, the fuel component separator 3 is placed in the relatively large space of the oil pan 4, so that the fuel component separation film 32 of the fuel component separator 3 can be made relatively large to improve the separating function of the fuel component separation film 32.

Here, it should be noted that FIG. 10 additionally depicts the oil pump 42 and the oil filter 43 of the oil circuit (the oil path) 41. Although not illustrated in FIG. 1 for the sake of simplicity, the oil is supplied from the oil pan 4 to the engine 1 through the following path. Specifically, the oil from the oil pan 4 is drawn to the oil pump 42 through a passage 41a of the oil circuit 41. Then, the oil, which is drawn into the oil pump 42, is pressurized in the oil pump 42 and is delivered to the oil filter 43 through a passage 41b. The oil is filtered through the oil filter 43 and is supplied to the engine 1 through a passage 41c to lubricate the components of the engine 1.

### FOURTH EMBODIMENT

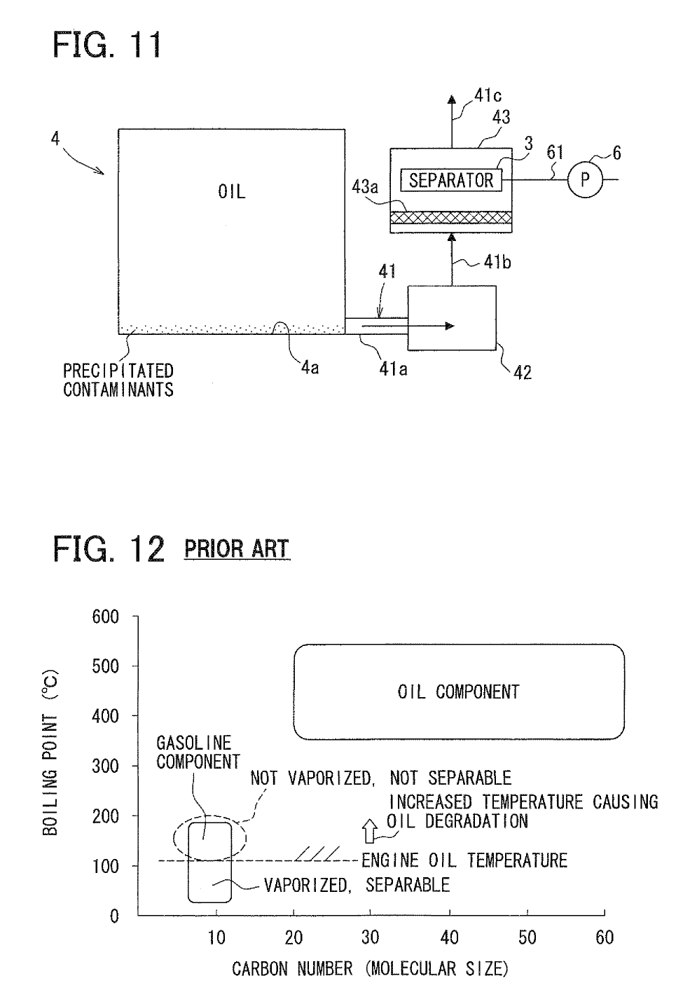

FIG. 11 shows a fourth embodiment of the present invention. In the fourth embodiment, the fuel component separator 3 is replaced into the oil filter 43 of the oil circuit 41, which includes the oil pan 4.

As shown in FIG. 11, in the oil circuit 41, the oil pump 42 draws the oil from the oil pan 4. The oil pump 42 and the oil filter 43 are provided at the passages 41a, 41b, 41c of the oil circuit 41, which are located on the downstream side of the oil pan 4.

In the present instance, it is preferred to place the fuel component separator (the separating means) 3 in the oil filter 43 although the fuel component separator (the separating means) 3 may be placed in the oil filter 43 or a portion (e.g., in the passage 41c) of the oil circuit 41, which is located on the downstream side of the oil filter 43.

The oil filter 43 filters the contaminants contained in the oil. Thus, in the case where the fuel component separator 3 is placed in the oil filter 43, the filtered clean oil is present in the oil filter 43, which forms the anterior chamber of the fuel component separator 3 therein. Therefore, the adhesion of the contaminants to the fuel component separation film 32 can be advantageously limited.

Furthermore, in the oil filter 43, the fuel component separator 3 is desirably placed on the downstream side of a filtering material 43a contained in the housing of the oil filter 43. In this way, the filtered most clean oil can be directly supplied to the fuel component separator 3.

Now, modifications of the above embodiments will be described.

In the above embodiments, the gasoline is illustrated as the fuel, which is mixed into the oil. However, the fuel may be any one of, for example, a light oil (also referred to as a light diesel oil, a diesel oil, a light mineral oil or the like); a biodiesel fuel; a mixture fuel of the light oil and the biodiesel fuel; a gasoline; and a gasoline mixture fuel of the gasoline and alcohol.

Among the above various fuels, the gasoline or the gasoline mixture fuel of gasoline and alcohol may be particularly preferred. In the case where the gasoline or the gasoline mixture fuel is used as the fuel of the above embodiments, the molecular size difference of the fuel component relative to the oil component is significantly large. Therefore, the oil dilution limiting function can be effectively performed.

Additional advantages and modifications will readily occur to those skilled in the art. The invention in its broader terms is therefore not limited to the specific details, representative apparatus, and illustrative examples shown and described.

What is claimed is:

1. A dilution limiting device comprising:
an anterior chamber that receives a mixture fluid, in which a lubricant fluid having lubricity and a diluent fluid are mixed, wherein the diluent fluid reduces the lubricity of the lubricant fluid;
a semipermeable separation film that is permeable to the diluent fluid in the anterior chamber and is not permeable to the lubricant fluid in the anterior chamber due to a molecular size difference between the lubricant fluid and the diluent fluid, so that the semipermeable separation film selectively separates the diluent fluid from the mixture fluid; and
a posterior chamber that is placed on an opposite side of the semipermeable separation film, which is opposite from the anterior chamber, wherein the posterior chamber receives the separated diluent fluid, which is separated by the semipermeable separation film.

2. The dilution limiting device according to claim 1, further comprising a differential pressure creating means for creating a pressure difference between the posterior chamber and the anterior chamber such that an internal pressure of the posterior chamber is higher than an internal pressure of the anterior chamber in a non-active separating period, during which the diluent fluid contained in the mixture fluid at the anterior chamber is not actively separated into the posterior chamber through the semipermeable separation film.

3. The dilution limiting device according to claim 1, further comprising a differential pressure creating means for creating a pressure difference between the anterior chamber and the posterior chamber such that an internal pressure of the anterior chamber is higher than an internal pressure of the posterior chamber in an active separating period, during which the diluent fluid contained in the mixture fluid at the anterior chamber is actively separated into the posterior chamber through the semipermeable separation film.

4. The dilution limiting device according to claim 1, further comprising a pressure pump that is operable in both of a first pumping direction and a second pumping direction, which are opposite to each other, wherein:
the pressure pump is driven in the first direction to create a pressure difference between the posterior chamber and the anterior chamber such that an internal pressure of the posterior chamber is higher than an internal pressure of the anterior chamber in a non-active separating period, during which the diluent fluid contained in the mixture fluid at the anterior chamber is not actively separated into the posterior chamber through the semipermeable separation film; and
the pressure pump is driven in the second direction to create a pressure difference between the anterior chamber and the posterior chamber such that the internal pressure of the anterior chamber is higher than the internal pressure of the posterior chamber in an active separating period, during which the diluent fluid contained in the mixture fluid at the anterior chamber is actively separated into the posterior chamber through the semipermeable separation film.

5. The dilution limiting device according to claim 1, wherein the semipermeable separation film is one of a zeolite film and a mesoporous film.

6. The dilution limiting device according to claim 1, further comprising a porous support body that is covered by and supports the semipermeable separation film, wherein the porous support body and the semipermeable separation film forms a separation wall that is placed between the anterior chamber and the posterior chamber.

7. The dilution limiting device according to claim 1, wherein:
the dilution limiting device is used in an internal combustion engine, in which a fuel is supplied as the dilution fluid into a combustion chamber of each corresponding cylinder and is combusted to produce a power, and a lubricant oil is used as the lubricant fluid to lubricate each corresponding part of the internal combustion engine;
the dilution limiting device further comprises a separating means for selectively separating a fuel component mixed in the lubricant oil, which includes contaminants, and is used in the internal combustion engine; and
the separating means includes the semipermeable separation film, the anterior chamber and the posterior chamber while the anterior chamber is partitioned from the posterior chamber through the semipermeable separation film.

8. The dilution limiting device according to claim 7, wherein the separating means is placed in one of:
a lubricant oil storage of the internal combustion engine;
a filtering device that is placed in a lubricant oil path, which includes the lubricant oil storage, wherein the filtering device includes a filtering material that filters the contaminants contained in the lubricant oil; and
a portion of the lubricant oil path, which is located on a downstream side of the filtering device.

9. The dilution limiting device according to claim 8, wherein the separating means is placed in the lubricant oil storage such that the separating means is spaced from a bottom portion of the lubricant oil storage.

10. The dilution limiting device according to claim 8, wherein the separating means is placed in the filtering device at a location, which is on a downstream side of the filtering material.

11. The dilution limiting device according to claim 7, wherein the fuel, which is supplied to the combustion chamber, is one of:
a light oil;
a biodiesel fuel;
a mixture fuel, in which the light oil and the biodiesel fuel are mixed;
a gasoline; and
a gasoline mixture fuel, in which the gasoline and alcohol are mixed.

12. The dilution limiting device according to claim 11, wherein the fuel, which is supplied to the combustion chamber, is one of:
the gasoline; and
the gasoline mixture fuel, in which the gasoline and the alcohol are mixed.
